(19) United States
(12) Patent Application Publication
(10) Pub. No.: US 2025/0130796 A1
(43) Pub. Date: Apr. 24, 2025

(54) CACHE MEMORY EQUIPPED ARITHMETIC DEVICE

(71) Applicant: Fujitsu Limited, Kawasaki-shi (JP)

(72) Inventor: Shiho NAKAHARA, Nerima (JP)

(73) Assignee: Fujitsu Limited, Kawasaki-shi (JP)

(21) Appl. No.: 18/884,776

(22) Filed: Sep. 13, 2024

(30) Foreign Application Priority Data
Oct. 24, 2023 (JP) 2023-182658

(51) Int. Cl. G06F 9/30

(52) U.S. Cl. CPC G06F 9/3001; G06F 9/30047

(57) ABSTRACT

A cache memory equipped arithmetic device includes a first semiconductor die configured to include a plurality of arithmetic circuits, a second semiconductor die stacked over the first semiconductor die, and configured to include a plurality of cache memories, a cache memory of the plurality of cache memories forming a pair with an arithmetic circuit of the plurality of arithmetic circuits, and an operation management circuit configured to manage operation of the first semiconductor die and the second semiconductor die, wherein the arithmetic circuit and the cache memory, which form the pair, at least partially overlap each other in plan view, and wherein the operation management circuit selectively operates one of the arithmetic circuit and the cache memory paired with the arithmetic circuit, based on arithmetic intensity needed for the plurality of arithmetic circuits.

### CROSS-REFERENCE TO RELATED APPLICATION

This application is based upon and claims the benefit of priority of the prior Japanese Patent Application No. 2023-182658, filed on Oct. 24, 2023, the entire contents of which are incorporated herein by reference.

### FIELD

The embodiment discussed herein is related to a cache memory equipped arithmetic device.

### BACKGROUND

An arithmetic device including a three-dimensional stacked die in which a plurality of semiconductor dies is stacked is known. For example, a three-dimensional stacked die in which a memory die and a logic die for memory latency control are stacked has been proposed.

The arithmetic device includes an arithmetic unit that performs an operation and a cache memory that accumulates data. In order to increase the number of arithmetic units, which are called cores, and the number of cache memories and to improve computing power, memory capacity, and the like, it is advantageous to adopt a stacked structure in which the arithmetic units and the cache memories are stacked.

U.S. Patent Application Publication No. 2023/0125009 is disclosed as related art.

### SUMMARY

According to an aspect of the embodiments, a cache memory equipped arithmetic device includes a first semiconductor die configured to include a plurality of arithmetic circuits, a second semiconductor die stacked over the first semiconductor die, and configured to include a plurality of cache memories, a cache memory of the plurality of cache memories forming a pair with an arithmetic circuit of the plurality of arithmetic circuits, and an operation management circuit configured to manage operation of the first semiconductor die and the second semiconductor die, wherein the arithmetic circuit and the cache memory, which form the pair, at least partially overlap each other in plan view, and wherein the operation management circuit selectively operates one of the arithmetic circuit and the cache memory paired with the arithmetic circuit, based on arithmetic intensity needed for the plurality of arithmetic circuits.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A to 1C are diagrams illustrating an exemplary stacked structure of an arithmetic unit and a cache memory;

FIG. 2 is a side view illustrating an exemplary arithmetic device according to an embodiment;

FIG. 3 is a side view illustrating an exemplary three-dimensional stacked die in the arithmetic device illustrated in FIG. 2;

FIG. 4 is a top view illustrating an exemplary logic die and memory die in the arithmetic device illustrated in FIG. 2;

FIG. 5 is a diagram illustrating an exemplary relationship between arithmetic performance and arithmetic intensity;

FIGS. 6A to 6C are diagrams illustrating exemplary processing of selectively operating the arithmetic unit and the cache memory;

FIG. 7 is a top view illustrating another exemplary logic die and memory die in the arithmetic device illustrated in FIG. 2;

FIG. 8 is a circuit diagram of a first example of the arithmetic device;

FIG. 9 is a sequence diagram of the arithmetic device according to the first example;

FIG. 10 is a circuit diagram of a second example of the arithmetic device;

FIG. 11 is a sequence diagram of the arithmetic device according to the second example;

FIG. 12 is a flowchart illustrating an exemplary process of adjusting the number of operation cores in FIG. 11;

FIG. 13 is a circuit diagram of a third example of the arithmetic device;

FIG. 14 is a sequence diagram of the arithmetic device according to the fourth example;

FIG. 15 is a flowchart illustrating an exemplary process of determining the number of operation cores in FIG. 14;

FIG. 16 is a circuit diagram of a fifth example of the arithmetic device;

FIG. 17 is a sequence diagram of the arithmetic device according to the fifth example;

FIG. 18 is a flowchart illustrating an exemplary timer process in FIG. 17;

FIG. 19 is a flowchart illustrating a process of terminating the timer process in FIG. 17; and

FIG. 20 is a top view illustrating variations of the logic die and the memory die in the arithmetic device.

### DESCRIPTION OF EMBODIMENTS

In the case where the arithmetic unit and the cache memory are stacked, the cache memory may become inoperable due to heat generation by the arithmetic unit.

### [A] Related Art

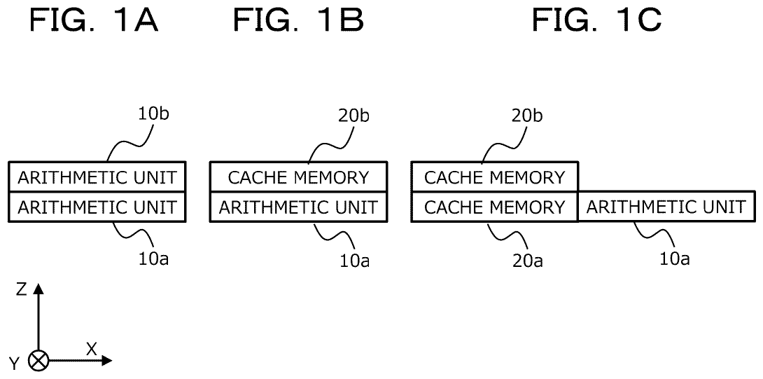

FIGS. 1A to 1C are diagrams illustrating an exemplary stacked structure of an arithmetic unit 10 (e.g., 10a and 10b in the drawing) and a cache memory 20 (e.g., 20a and 20b in the drawing). A calorific value of the arithmetic unit 10 is larger than a calorific value of the cache memory 20. Thus, as illustrated in FIG. 1A, it is difficult to adopt a structure of a three-dimensional stacked die in which a plurality of arithmetic units 10a and 10b is stacked.

As illustrated in FIG. 1B, also in a three-dimensional stacked die in which the arithmetic unit 10a and the cache memory 20b are stacked, heat dissipation design is needed such that a circuit operation failure of the cache memory 20b does not occur due to a temperature rise caused by heat generation of the arithmetic unit 10a.

In order to reduce the influence of the heat generation of the arithmetic unit 10a, as illustrated in FIG. 1C, a stacked structure is adopted in which the arithmetic unit 10 and the cache memory 20 are disposed not to overlap each other in plan view. However, as illustrated in FIG. 1C, avoiding stacking of the arithmetic unit 10 and the cache memory 20 serves as a constraint in increasing the number of the arithmetic units 10 and the cache memories 20 per unit area of the die. Therefore, improvement of computing power of the arithmetic device and improvement of capacity and the like of the cache memory 20 are hindered.

According to an embodiment, the influence exerted on the operation of the cache memory caused by heat generation of the arithmetic unit 10 may be reduced even in the stacked structure in which the arithmetic unit 10 and the cache memory 20 are stacked as in FIG. 1B.

### [B] Embodiments

Hereinafter, embodiments of techniques capable of reducing an influence exerted on operation of a cache memory caused by heat generation of an arithmetic unit in a three-dimensional stacked die in which the arithmetic unit and the cache memory are stacked will be described with reference to the drawings. Note that the embodiments to be described below is merely an example, and there is no intention to exclude application of various modifications and techniques not explicitly described in the embodiments. For example, the present embodiments may be variously modified and implemented without departing from the gist thereof. Furthermore, each of the drawing is not intended to include only components illustrated in the drawings, and may include another function and the like.

Hereinafter, each of the same reference signs denotes a similar part in the drawings, and thus description thereof will be omitted. In the present specification, each of upper surfaces and lower surfaces of a logic die and a memory die, which are semiconductor dies, may be parallel to the X-Y plane. The X-axis direction and the Y-axis direction are directions perpendicular to each other, and the Z-axis direction is a direction perpendicular to the X-Y plane. In the present specification, a plan view refers to a case of viewing a semiconductor die in the Z-axis direction.

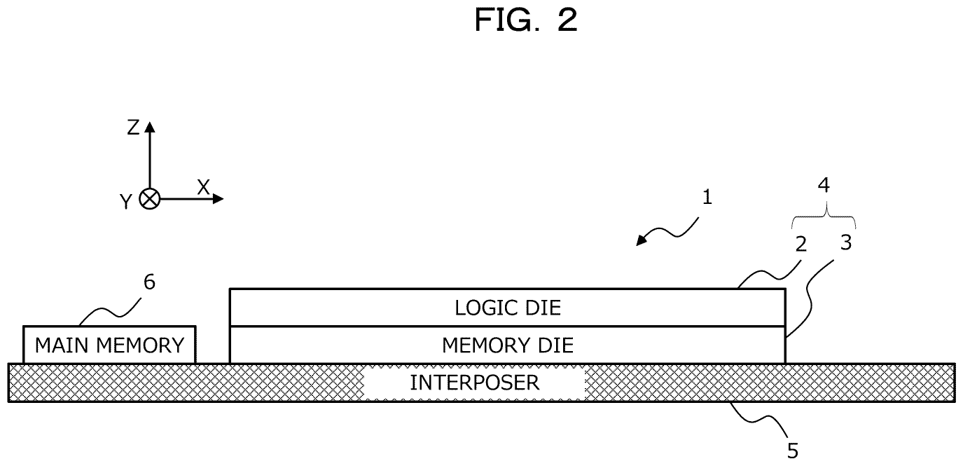

FIG. 2 is a side view illustrating an exemplary arithmetic device 1 according to the embodiment. The arithmetic device 1 includes a logic die 2 and a memory die 3. The arithmetic device 1 is an example of a cache memory equipped arithmetic device.

The logic die 2 and the memory die 3 are semiconductor dies including silicon or a compound semiconductor. The semiconductor die may be referred to as a semiconductor chip. The logic die 2 is an exemplary first semiconductor die, and the memory die 3 is an exemplary second semiconductor die stacked over the first semiconductor die.

The logic die 2 and the memory die 3 are stacked by a connection structure (not illustrated) to form a three-dimensional stacked die 4.

The arithmetic device 1 may include an interposer 5. The interposer 5 is an exemplary substrate. The interposer 5 electrically couples the three-dimensional stacked die 4 to a printed circuit board (not illustrated). The interposer 5 may be a silicon interposer, or may be an organic interposer. The three-dimensional stacked die 4 may be arranged above another semiconductor substrate or organic substrate instead of the interposer 5.

The coupling between the logic die 2 and the memory die 3 may be a direct Cu—Cu connection, may be coupling based on a through-silicon via (TSV), or may be coupling based on a solder-based micro-bump technique. Likewise, the interposer 5 and the three-dimensional stacked die 4 may be coupled to each other based on various coupling techniques, such as the solder-based micro-bump technique.

In the example illustrated in FIG. 2, the interposer 5, the memory die 3, and the logic die 2 are stacked in the Z direction in the arrangement order of the interposer 5, the memory die 3, and the logic die 2. In this case, the memory die 3 is stacked close to the interposer 5. However, the arithmetic device 1 is not limited to this case. The interposer 5, the memory die 3, and the logic die 2 may be stacked in the Z direction in the arrangement order of the interposer 5, the logic die 2, and the memory die 3. In this case, the logic die 2 is stacked close to the interposer 5.

Not only the three-dimensional stacked die 4 but also a main memory 6 and another circuit may be arranged above the interposer 5. For example, a die provided with a central processing unit (CPU) may be arranged above the interposer 5.

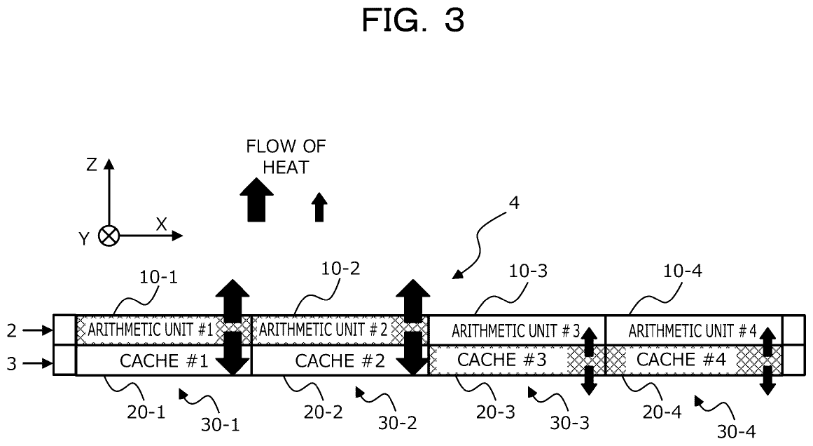

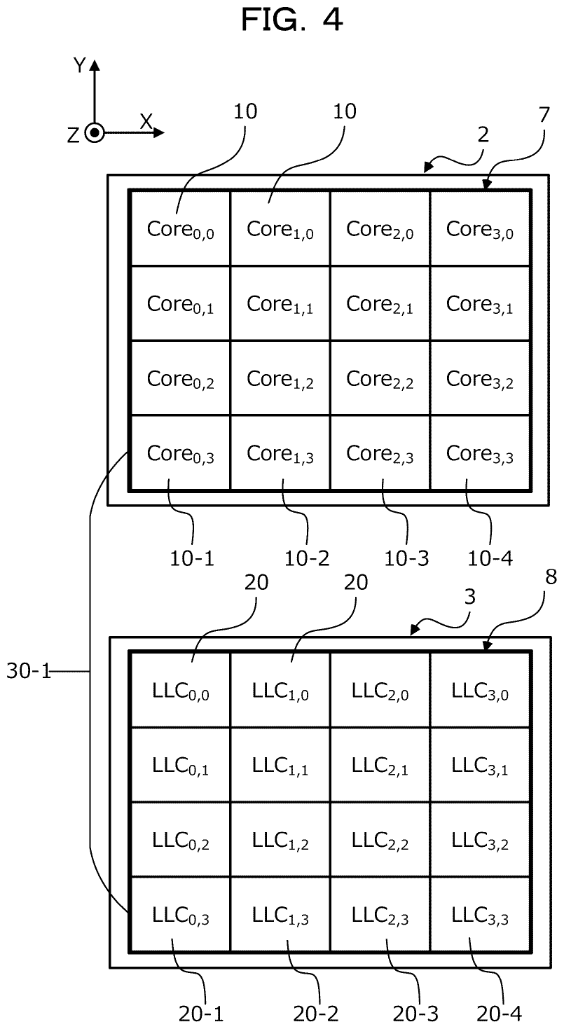

FIG. 3 is a side view illustrating an example of the logic die 2 and the memory die 3 in the arithmetic device 1 illustrated in FIG. 2. FIG. 4 is a top view illustrating an example of the logic die 2 and the memory die 3 in the arithmetic device 1 illustrated in FIG. 2.

As illustrated in FIGS. 3 and 4, the logic die 2 includes a plurality of arithmetic units 10. In FIG. 3, a plurality of arithmetic units 10-1 to 10-4 (arithmetic units #1 to #4 in the drawing) is illustrated. In FIG. 4, the logic die 2 includes 16 arithmetic units 10 from Core_{0,0} to Core_{3,3} as the plurality of arithmetic units 10. However, the number of the arithmetic units 10 is not limited to this case. The number of the arithmetic units 10 may be two or more.

As illustrated in FIG. 4, the plurality of arithmetic units 10 may be formed in an arithmetic unit area 7 of the logic die 2. The arithmetic unit area 7 may be, for example, rectangular. While there is one arithmetic unit area 7 in FIG. 4, the arithmetic unit area 7 may include a plurality of areas unlike the case of FIG. 4.

Each of the arithmetic units 10 may be a processor core (displayed as Core_{i,j} (i and j are integers of 0 or more) in FIG. 4). The processor core is an arithmetic unit that independently functions inside the arithmetic device 1 (processor). The processor core may include a logic circuit for interpreting and executing a command sequence. Each processor core may include a primary cache memory (L1 cache). Note that the logic die 2 may include a shared circuit shared by the plurality of arithmetic units 10. The shared circuit may be provided with an interface circuit that performs input/output with the outside and a secondary cache memory (L2 cache). However, the internal configuration of the arithmetic unit 10 is not limited to this case. Since the internal configuration of the arithmetic unit 10 itself is similar to that of a common arithmetic unit, illustration thereof is omitted, and detailed description thereof is omitted.

As illustrated in FIGS. 3 and 4, the memory die 3 includes a plurality of cache memories 20. In FIG. 3, a plurality of cache memories 20-1 to 20-4 (displayed as caches #1 to #4 in the drawing) is illustrated. In FIG. 4, the memory die 3 includes 16 cache memories 20 from LLC_{0,0} to LLC_{3,3} as the plurality of cache memories 20. However, the number of cache memories 20 is not limited to this case. The number of the cache memories 20 may be two or more.

As illustrated in FIG. 4, the plurality of cache memories 20 may be formed in a memory area 8 of the memory die 3. The memory area 8 may correspond to the arithmetic unit area 7. For example, the memory area 8 may be rectangular. While there is one memory area 8 in FIG. 4, the memory area 8 may include a plurality of areas unlike FIG. 4.

A cache memory in the arithmetic device may commonly include a primary cache (level 1 (L1) cache), a secondary cache (level 2 (L2) cache), a tertiary cache (level 3 (L3) cache), and the like in the order of proximity to the arithmetic unit 10. A cache memory closer to the arithmetic unit 10 may have a higher speed and a smaller capacity, and the read/write speed may be lower and the capacity may be larger as the cache memory is away from the arithmetic unit 10. As an example, the cache memory 20 in the present example may be a last level cache (LLC). The LLC may be substantially a tertiary cache (L3 cache). However, the LLC may be a quaternary cache (level 4 (L4) cache) or the like depending on the architecture.

All elements of the logic die 2 and the memory die 3, which are, for example, the processor cores, may be accessible to the cache memory 20.

Each of the cache memories 20 included in the memory die 3 may be called a memory array. The memory die 3 includes a plurality of memory arrays. Each of the cache memories 20 is controlled by a memory selection signal (not illustrated). Each of the cache memories 20 (memory arrays) includes a plurality of memory cells (not illustrated). As an example, each of the memory cells may be a static random access memory (SRAM) cell. The memory die 3 may include shared bus wiring (not illustrated) for transmitting signals to each of the memory cells, and a driver circuit (not illustrated) coupled to the shared bus wiring. Since the internal configuration of the cache memory 20 itself is similar to that of a common cache memory, illustration thereof is omitted, and detailed description thereof is omitted.

Each of the cache memories 20 forms a pair 30 with any arithmetic unit 10 of the plurality of arithmetic units 10. In FIG. 4, Core_{i,j} and LLC_{i,j}, which have the same subscript, form the pair 30. In the example illustrated in FIG. 3, the arithmetic unit 10-1 and the cache memory 20-1 form a pair 30-1. Likewise, the arithmetic units 10-2, 10-3, and 10-4 and the cache memories 20-2, 20-3, and 20-4 form pairs 30-2, 30-3, and 30-4, respectively.

The arithmetic unit 10 and the cache memory 20 forming the pair 30 at least partially overlap each other in plan view. As illustrated in FIG. 3, in plan view, the arithmetic units 10-1, 10-2, 10-3, and 10-4 at least partially overlap the cache memories 20-1, 20-2, 20-3, and 20-4, respectively.

A first area occupied by each of the arithmetic units 10 in plan view corresponds to a second area occupied by the cache memory 20, which forms the pair 30, in plan view. The first area may be larger than the second area, the first area may be smaller than the second area, and the first area may have the same area as the second area. One first area may overlap one second area, and one first area may not overlap a plurality of second areas. One second area may overlap one first area, and one second area may not overlap a plurality of first areas.

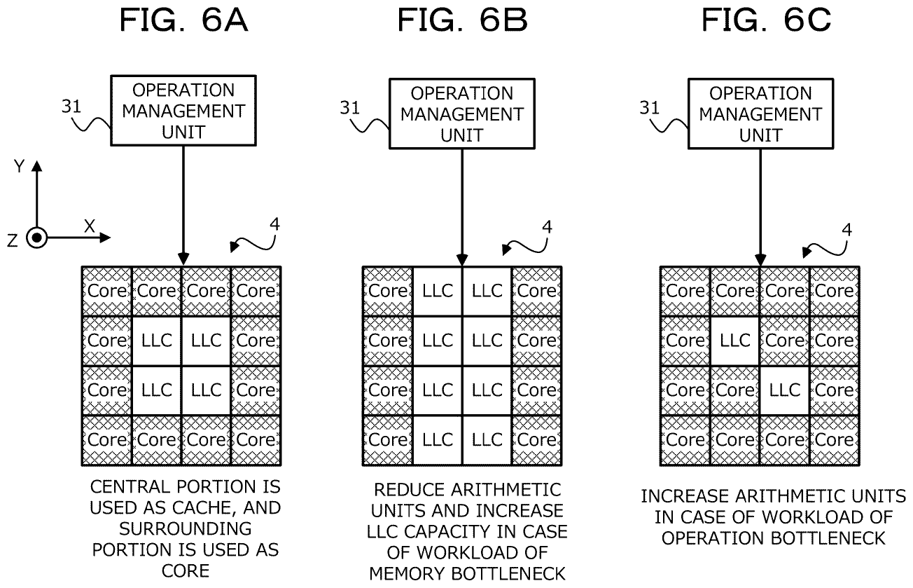

The arithmetic unit 10 and the cache memory 20, which forms the pair 30 with the arithmetic unit 10, are controlled such that either one of them selectively operates. An operation management unit 31 to be described later (see FIGS. 6A to 6C, etc. to be described later) selectively operates the arithmetic unit 10 and the cache memory 20.

In FIG. 4, Core_{i,j} and LLC_{i,j} having the same subscript are not used at the same time, but are used exclusively. Core_{i,j} is disabled (paused) when LLC_{i,j} is enabled, and LLC_{i,j} is disabled (not readable/writable) when Core_{i,j} is enabled.

In FIG. 3, elements that selectively operate are hatched among the arithmetic units 10 and the cache memories 20 forming the pairs 30. For example, in the state of FIG. 3, in the pair 30-1 of the arithmetic unit 10-1 and the cache memory 20-1, the arithmetic unit 10-1 operates. In the pair 30-2 of the arithmetic unit 10-2 and the cache memory 20-2, the arithmetic unit 10-2 operates. In the pair 30-3 of the arithmetic unit 10-3 and the cache memory 20-3, the cache memory 20-3 operates. In the pair 30-4 of the arithmetic unit 10-4 and the cache memory 20-4, the cache memory 20-4 operates.

In FIG. 3, an arrow schematically indicates a flow of heat. A calorific value from the arithmetic unit 10 is larger than a calorific value from the cache memory 20. Thickness of the arrow schematically indicates magnitude of the calorific value.

During operation of the arithmetic units 10-1 and 10-2, temperatures of the nearest cache memories 20-1 and 20-2, which form the pairs 30 with them, may be higher than a predetermined value. However, since the arithmetic device 1 does not use the cache memories 20-1 and 20-2 during the operation of the arithmetic units 10-1 and 10-2, occurrence of a problem of circuit operation failure in the cache memories 20-1 and 20-2 is suppressed.

During operation of the cache memories 20-3 and 20-4, the nearest arithmetic units 10-3 and 10-4, which form the pairs 30 with them, are unused, and no heat is generated from the arithmetic units 10-3 and 10-4. Thus, temperatures of the cache memories 20-3 and 20-4 do not reach the predetermined value. As a result, occurrence of a problem of circuit operation failure is suppressed.

The arithmetic device 1 (e.g., operation management unit 31 in FIGS. 6A to 6C to be described later) switches an object to be operated between the arithmetic unit 10 and the cache memory 20 forming the pair 30. The operation management unit 31 selectively operates either the arithmetic unit 10 or the cache memory 20 paired with the arithmetic unit 10 depending on arithmetic intensity needed for the plurality of arithmetic units 10.

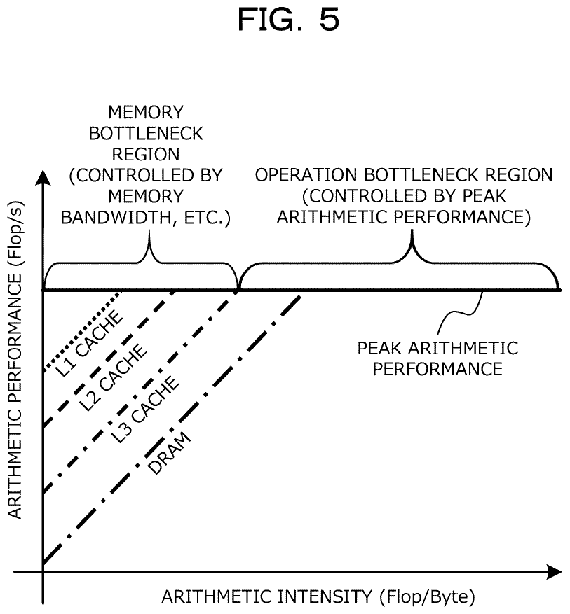

FIG. 5 is a diagram illustrating an exemplary relationship between arithmetic performance and arithmetic intensity. In FIG. 5, the horizontal axis represents arithmetic intensity (Flop/Byte), and the vertical axis represents arithmetic performance (Flop/s (second)).

The arithmetic intensity indicates the number of floating-point operations executed per 1-byte data transfer. The arithmetic intensity corresponds to a workload, which is magnitude of a load applied to the arithmetic device 1. The arithmetic intensity is higher as the workload is higher. Meanwhile, the arithmetic performance indicates the number of executable floating-point operations per unit time (one second).

As the arithmetic intensity is higher, a time needed for an operation of data transferred from a memory (e.g., operation time) is longer. A high-arithmetic-intensity region where the arithmetic intensity is high, in which the operation time is longer than a time (e.g., data transfer time) needed for data transfer (e.g., data reading, etc.) with the memory, will be referred to as an operation bottleneck region.

In the operation bottleneck region, the arithmetic performance is controlled by peak arithmetic performance determined by the number and performance of the arithmetic units 10. In the operation bottleneck region (region with high arithmetic intensity), the arithmetic performance is improved by enhancement of the total capacity of the arithmetic units 10 based on an increase in the number of the arithmetic units 10 or the like.

On the other hand, as the arithmetic intensity is lower, the operation time is shorter. A low-arithmetic-intensity region where the operation time is equal to or shorter than the data transfer time will be referred to as a memory bottleneck region.

In the memory bottleneck region, the arithmetic performance is controlled by a memory bandwidth or the like. The memory bandwidth indicates a data amount (Byte/s (second)) that may be transferred per second, and is also referred to as memory performance or a memory band. The memory bandwidth varies depending on a type of the memory. The memory bandwidth is the highest in the L1 cache, and is lower in the order of the L2 cache, the L3 cache, and the main memory 6 (dynamic random access memory (DRAM)).

In a case where the cache memory 20 is the L3 cache, data is read from and written to the main memory 6 when the data amount used for calculation exceeds the total capacity of the plurality of cache memories 20. Thus, the rate-limiting memory bandwidth is lowered, and as a result, the arithmetic performance may be lowered.

In the memory bottleneck region (region with low arithmetic intensity), the total memory capacity of the plurality of cache memories 20 may be enhanced based on an increase in the number of the cache memories 20. As a result, a frequency of data reading/writing in the main memory 6 is reduced, which suppresses a decrease in the rate-limiting memory bandwidth. Therefore, a decrease in the arithmetic performance is suppressed. For example, by increasing the number of the cache memories 20, the arithmetic performance improves in the memory bottleneck region.

Note that, while the arithmetic intensity has been described by being divided into the two regions of the memory bottleneck region (region with low arithmetic intensity) and the operation bottleneck region (region with high arithmetic intensity) in FIG. 5, the arithmetic intensity may be classified into three or more regions. As an example, the arithmetic intensity may be classified into a region with low arithmetic intensity where the arithmetic intensity<a first threshold, an intermediate region where the first threshold≤the arithmetic intensity≤a second threshold, and a region with high arithmetic intensity where the second threshold<the arithmetic intensity.

FIGS. 6A to 6C are diagrams illustrating exemplary processing of selectively operating the arithmetic units 10 and the cache memories 20. In FIGS. 6A to 6C, a portion denoted by Core indicates that the arithmetic unit 10 operates, and a portion denoted by LLC indicates that the cache memory 20 operates.

The operation management unit 31 manages operation of the three-dimensional stacked die 4. For example, the operation management unit 31 manages operation of the logic die 2 (e.g., first semiconductor die) and the memory die 3 (e.g., second semiconductor die). The operation management unit 31 selectively operates either the arithmetic unit 10 or the cache memory 20, which forms the pair 30 with the arithmetic unit 10, depending on the arithmetic intensity needed for the plurality of arithmetic units 10.

The operation management unit 31 may be implemented as one function of a CPU (not illustrated) provided in the logic die 2 or another die, or may be implemented by a dedicated circuit provided in at least one of the logic die 2 and the memory die 3.

FIG. 6A is an example of an initial operation state of the three-dimensional stacked die 4. The operation management unit 31 may set a ratio (operation ratio) for operating the arithmetic unit 10 (denoted as Core in FIGS. 6A to 6C) in the outer edge portion of the three-dimensional stacked die 4 in the X-Y plane to be higher than an operation ratio of the cache memory 20 (denoted as LLC in FIGS. 6A to 6C) in the central portion. The central portion may be a region within a range of a predetermined distance from the center of gravity of a rectangular upper surface of the three-dimensional stacked die 4 parallel to the X-Y plane, and the outer edge portion may be a region outside the range of the distance.

The outer edge portion is easier to dissipate heat than the central portion. Thus, it is advantageous in terms of heat dissipation design to drive the arithmetic unit 10, which has a calorific value larger than that of the cache memory 20, at the outer edge portion. However, the distribution and the number of the arithmetic units 10 to be operated in the initial operation state in the X-Y plane are not limited to the case of FIG. 6A.

FIG. 6B is an exemplary operation state of the three-dimensional stacked die 4 in the memory bottleneck region. FIG. 6C is an exemplary operation state of the three-dimensional stacked die 4 in the operation bottleneck region.

As illustrated in FIG. 6B, in the memory bottleneck region where the arithmetic intensity (e.g., workload) is lowered, the operation management unit 31 decreases the number of the arithmetic units 10 to be in the operation state and increases the number of the cache memories 20 to be in the operation state. As illustrated in FIG. 6C, in the operation bottleneck region where the arithmetic intensity is higher, the operation management unit 31 increases the number of the arithmetic units 10 to be in the operation state and decreases the number of the cache memories 20 to be in the operation state.

Note that, also in the states of FIGS. 6B and 6C, the operation ratio of the arithmetic unit 10 in the outer edge portion may be higher than the operation ratio of the arithmetic unit 10 in the central portion. The distribution and the number of the arithmetic units 10 to be operated in the memory bottleneck region and the operation bottleneck region in the X-Y plane are not limited to the case of FIGS. 6B and 6C.

While the three states of FIGS. 6A, 6B, and 6C are illustrated in FIGS. 6A to 6C, the operation management unit 31 may switch the number of the arithmetic units 10 and the number of the cache memories 20 to be in the operation state between two states, or between four or more states. As an example, the operation management unit 31 may switch the number of the arithmetic units 10 and the number of the cache memories 20 to be in the operation state between two states as illustrated in FIGS. 6B and 6C.

It is sufficient if the operation management unit 31 selectively operates either the arithmetic unit 10 or the cache memory 20, which forms the pair 30 with the arithmetic unit 10, depending on the arithmetic intensity needed for the plurality of arithmetic units 10. The operation control of the arithmetic unit 10 and the cache memory 20 depending on the arithmetic intensity may include a case of operating either the arithmetic unit 10 or the cache memory 20 in the pair 30 based on a detection result of a usage rate (operation rate) of the arithmetic unit 10 and the cache memory 20, or the like. Furthermore, the operation control may include a case of designating, by a program, a list of the arithmetic units 10 (e.g., operation cores) to be operated in advance depending on a level of the arithmetic intensity predicted based on processing content regardless of the detection result.

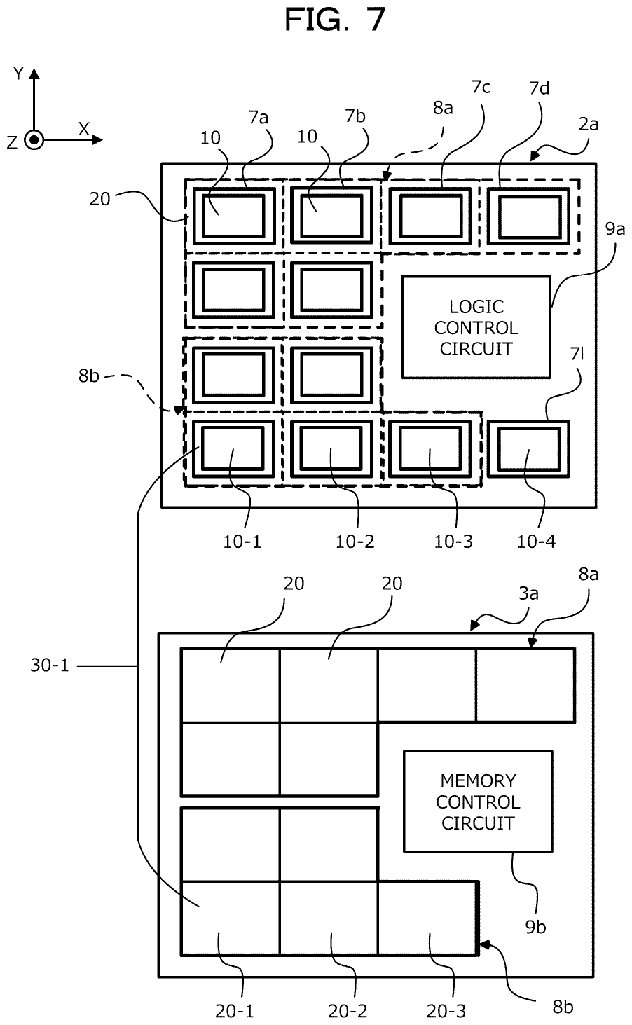

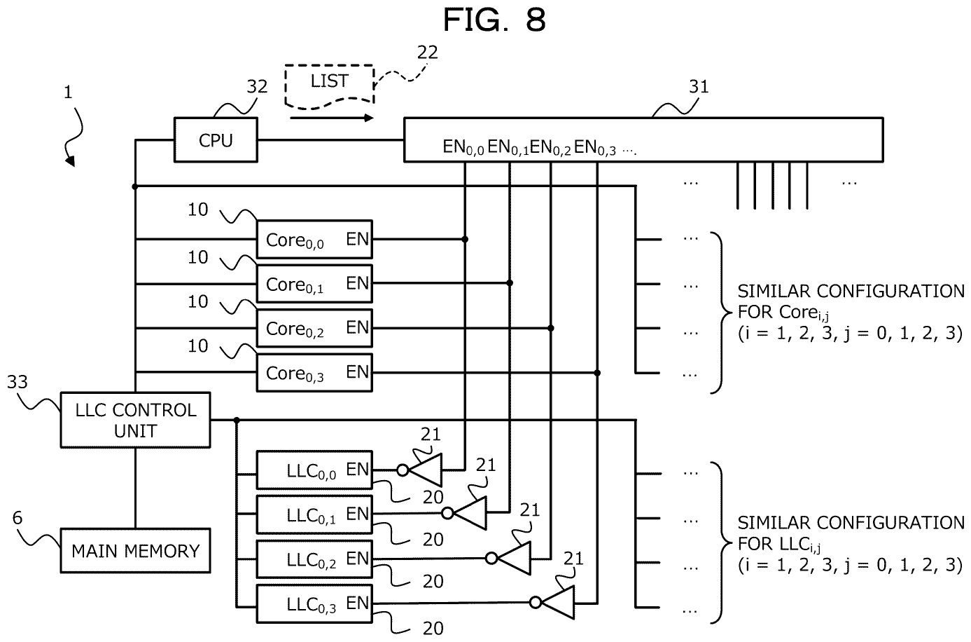

FIG. 7 is a top view illustrating another example of a logic die 2a and a memory die 3a in the arithmetic device illustrated in FIG. 2. The logic die 2a and the memory die 3a are not limited to the configurations illustrated in FIG. 4. The logic die 2a may be provided with not only the arithmetic units 10 but also another logic control circuit 9a. The logic control circuit 9a may include, for example, the operation management unit 31, and may include a CPU (CPU 32 in FIGS. 8, 10, 13, and 16 to be described later, etc.).

The memory die 3a may be provided with not only the cache memories 20 but also a memory control circuit 9b. The memory control circuit 9b may include an LLC control unit (LLC control unit 33, etc. in FIGS. 8, 10, 13, 16, etc. to be described later) for controlling operation of the cache memories 20, and may include the operation management unit 31 or a CPU.

As illustrated in FIG. 7, the logic die 2a may be provided with a plurality of arithmetic unit areas 7a, 7b, 7c, 7d, . . . , 7l, and the like. Note that an arithmetic unit area 7 may be provided at a part of an X-Y surface of the logic die 2a, and the arithmetic unit area 7 may not be rectangular.

As illustrated in FIG. 7, the memory die 3a is provided with a plurality of memory areas 8a, 8b, and the like. Note that the memory areas 8a and 8b may be provided at a part of an X-Y surface of the memory die 3a, and the memory areas 8a and 8b may not be rectangular.

As illustrated in FIG. 7, the first area occupied by each of the arithmetic units 10 in plan view may be smaller than the second area occupied by each of the cache memories 20, which form the pairs 30, in plan view. Also in this case, during the operation of the arithmetic units 10, temperatures of the nearest cache memories 20, which form the pairs 30 with them, are higher than the predetermined value. However, since the operation management unit 31 does not operate the nearest cache memories 20 during the operation of the arithmetic units 10, the occurrence of the problem of circuit operation failure is suppressed.

The arithmetic unit 10 having no cache memory 20 to form the pair 30 therewith may be provided, such as the arithmetic unit 10-4 illustrated in FIG. 7. As an example, the arithmetic unit 10-4 may perform processing in place of the CPU 32 in FIGS. 8, 10, 13, and 16 to be described later. In this case, the arithmetic unit 10-4 may operate independently of the operation of the cache memory 20.

As described above, according to the arithmetic device 1 according to the present embodiment, the operation management unit 31 operates the arithmetic units 10 and the cache memories 20 depending on the arithmetic intensity. In the three-dimensional stacked die 4 in which the arithmetic units 10 and the cache memories 20 are stacked, the influence exerted on the operation of the cache memories 20 caused by heat generation of the arithmetic units 10 may be reduced.

As a method of operating the arithmetic units 10 and the cache memories 20 depending on the arithmetic intensity, various examples are conceivable as described below.

### [B-1] First Example

### [B-1-1] Configuration

FIG. 8 is a circuit diagram of a first example of the arithmetic device 1. The first example is a case of designating, by a program, the arithmetic unit 10 (e.g., operation core) to be operated in advance. For example, in the first example, the operation management unit 31 determines the arithmetic unit 10 or the cache memory 20 to be operated in a plurality of pairs 30 based on a list 22 for specifying the arithmetic unit 10 or the cache memory 20 to be operated in advance. A user may determine the operation core in advance through the program.

The arithmetic device 1 includes the plurality of arithmetic units 10, the plurality of cache memories 20, and the operation management unit 31. Moreover, the arithmetic device 1 may include the CPU 32, the LLC control unit 33, and the main memory 6.

In the present example, Core_{i,j} (i=0, 1, 2, and 3, and j =0, 1, 2, and 3) is provided as the arithmetic unit 10, and LLC_{i,j} (i=0, 1, 2, and 3, and j=0, 1, 2, and 3) is provided as the cache memory 20. Note that i and j are not limited to the case of the present example, and only need to be integers.

The CPU 32 may be provided in the logic die 2, and may be provided in another die (not illustrated). The CPU 32 may take control of the plurality of arithmetic units 10. Furthermore, the CPU 32 may obtain the list 22 for specifying the arithmetic unit 10 and the cache memory 20 to be operated in advance, and may transmit the list 22 to the operation management unit 31.

As an example, the plurality of arithmetic units 10 may function as a hardware accelerator that serves to increase the arithmetic processing speed. In this case, the CPU 32 may control the hardware accelerator including the plurality of arithmetic units 10. However, at least one of the plurality of arithmetic units 10 may control the remaining arithmetic units 10 instead of the CPU 32.

The operation management unit 31 has an output terminal EN_{i,j}. The output terminal EN_{i,j} outputs either an enable signal or a disable signal to be input to an enable/disable input terminal EN of the plurality of arithmetic units 10 (Core_{i,j}). The number of the output terminals EN_{i,j} corresponds to the number of the arithmetic units 10. Based on information obtained from the CPU 32, the operation management unit 31 may transmit the enable signal to the input terminal EN of the arithmetic unit 10 to be operated, and may transmit the disable signal to the input terminal EN of the arithmetic unit 10 to be paused.

The enable signal and the disable signal output from the output terminal EN_{i,j} of the operation management unit 31 may be input to the enable/disable input terminal EN of each of the cache memories 20 (LLC_{i,j}) forming the pairs 30 via a NOT gate circuit 21 (inverter circuit). The NOT gate circuit 21 outputs a state opposite to the input. As a result, when the enable signal is applied to Core_{0,0}, the disable signal is applied to LLC_{0,0} forming the pair 30. When the disable signal is applied to Core_{0,0}, the enable signal is applied to LLC_{0,0}. Also in Core_{i,j} (i=0, 1, 2, and 3, and j=0, 1, 2, and 3) and LLC_{i,j} (i=0, 1, 2, and 3, and j=0, 1, 2, and 3), when the enable signal is applied to Core_{i,j}, the disable signal is applied to LLC_{i,j} having the same subscript. When the disable signal is applied to Core_{i,j}, the enable signal is applied to LLC_{i,j} having the same subscript.

In the case of using the NOT gate circuit 21 (inverter circuit), the arithmetic device 1 according to the present embodiment exclusively operates the arithmetic unit 10 and the cache memory 20 forming the pair 30, whereby a complex circuit configuration may be avoided. However, it is not limited to the case of the present example, and the operation management unit 31 may have both an output terminal for the arithmetic unit 10 and an output terminal for the cache memory 20.

The LLC control unit 33 in FIG. 8 controls the plurality of cache memories 20. Thus, instead of individually inputting enable/disable to the input terminal EN of each of the cache memories 20, enable/disable signals for each of the cache memories 20 may be input to the input terminal of the LLC control unit 33. In this case, the LLC control unit 33 includes a plurality of input terminals corresponding to the number of the cache memories 20 (LLC_{i,j}).

The LLC control unit 33 is communicably coupled to each of the arithmetic units 10, each of the cache memories 20, the main memory 6, and the CPU 32. The LLC control unit 33 may integrate the plurality of cache memories 20 into one set, and may associate a value calculated from a memory address by a certain procedure with the set. Data read from the main memory is stored in any cache memory 20 included in the set corresponding to the address. In this manner, the plurality of cache memories 20 may be integrated into one set, and may operate as one cache memory as a whole. For example, the i×j cache memories 20 may operate as one (i×j)-way set associative cache memory.

However, it is not limited to this case, and a direct mapping cache may be adopted in which each of the cache memories 20 is uniquely determined from a memory address and the plurality of cache memories 20 is individually used.

### [B-1-2] Operation

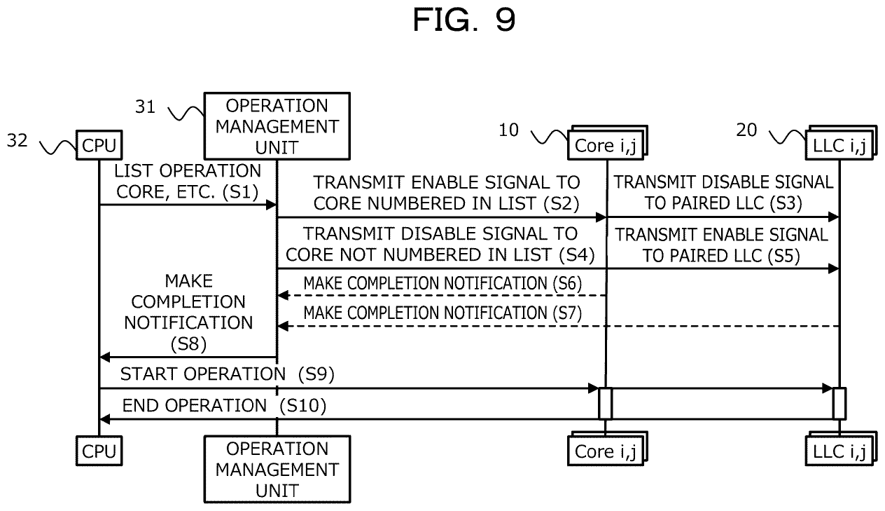

FIG. 9 is a sequence diagram of the arithmetic device 1 according to the first example. The CPU 32 obtains the list 22 for specifying the arithmetic unit 10 or the cache memory 20 to be operated in advance, and transfer the list 22 to the operation management unit 31 (operation S1).

The list 22 may be designated by a computer program. The list 22 may include numbers or subscripts as in FIG. 4 for identifying the arithmetic unit 10 to be operated among the pairs 30 as illustrated in FIG. 6.

As an example, two or more lists 22 are prepared such as a list for the operation bottleneck region (region with high arithmetic intensity), a list for the memory bottleneck region (region with low arithmetic intensity), and the like. In the program, the list 22 to be adopted may be designated depending on the arithmetic processing content.

A programmer (user) knows the arithmetic processing content. Thus, the programmer may predict a portion where the arithmetic intensity increases and a portion where the arithmetic intensity decreases in the arithmetic processing. As an example, in the program, the list 22 of the operation cores (e.g., operation core list corresponding to FIG. 6C) for the operation bottleneck region (region with high arithmetic intensity) may be designated in advance with respect to the portion where the arithmetic intensity is predicted to increase. With respect to the portion where the arithmetic intensity is predicted to decrease, the list 22 (e.g., list corresponding to FIG. 6B) for the memory bottleneck region (region with low arithmetic intensity) may be designated in advance in the program. Note that three or more lists 22 may be prepared in advance depending on the arithmetic intensity. In this case, the list 22 may be designated from among the three or more lists 22 according to a prediction level of the arithmetic intensity.

The operation management unit 31 transmits an enable signal to the arithmetic unit 10 numbered in the list 22 (e.g., operation core) (operation S2). The operation management unit 31 transmits a disable signal to the cache memory 20, which forms the pair 30 with the arithmetic unit 10 as the transmission destination of the enable signal (operation S3). The operation management unit 31 may use the output of the NOT gate circuit 21 as the disable signal to the cache memory 20 by inputting an enable signal to the NOT gate circuit 21 (inverter circuit).

The operation management unit 31 transmits a disable signal to the arithmetic unit 10 not numbered in the list 22 (e.g., non-operating core) (operation S4). The operation management unit 31 transmits an enable signal to the cache memory 20, which forms the pair 30 with the arithmetic unit 10 as the transmission destination of the disable signal (operation S5). The operation management unit 31 may use the output of the NOT gate circuit 21 as the enable signal to the cache memory 20 by inputting a disable signal to the NOT gate circuit 21.

The operation management unit 31 receives completion notification regarding the change in the operation state from each of the arithmetic units 10 and each of the cache memories 20 (operations S6 and S7). Upon reception of the completion notification from each of the arithmetic units 10 and each of the cache memories 20, the operation management unit 31 transmits completion notification to the CPU 32 (operation S8).

The CPU 32 instructs a start of the arithmetic processing based on the program content (operation S9). The arithmetic unit 10 and the cache memory 20 execute the arithmetic processing, data reading and writing, and the like. The CPU 32 receives operation completion notification from the arithmetic unit 10 (operation S10).

According to the arithmetic device 1 according to the first example, in the three-dimensional stacked die 4 in which the arithmetic units 10 and the cache memories 20 are stacked, the influence exerted on the operation of the cache memories 20 caused by heat generation of the arithmetic units 10 may be reduced. The operation management unit 31 makes determination based the list 22 for specifying the arithmetic units 10 and the cache memories 20 selected as objects to be operated in advance depending on the arithmetic intensity. Thus, physical measurement of the usage rate and the like of the arithmetic units 10 related to the arithmetic intensity may be omitted, whereby a processing time and notification data volume for obtaining and reflecting a measurement result may be reduced. The programmer is enabled to grasp a state in which the operation state of the specific arithmetic units 10 or cache memories 20 is switched.

### [B-2] Second Example

### [B-2-1] Configuration

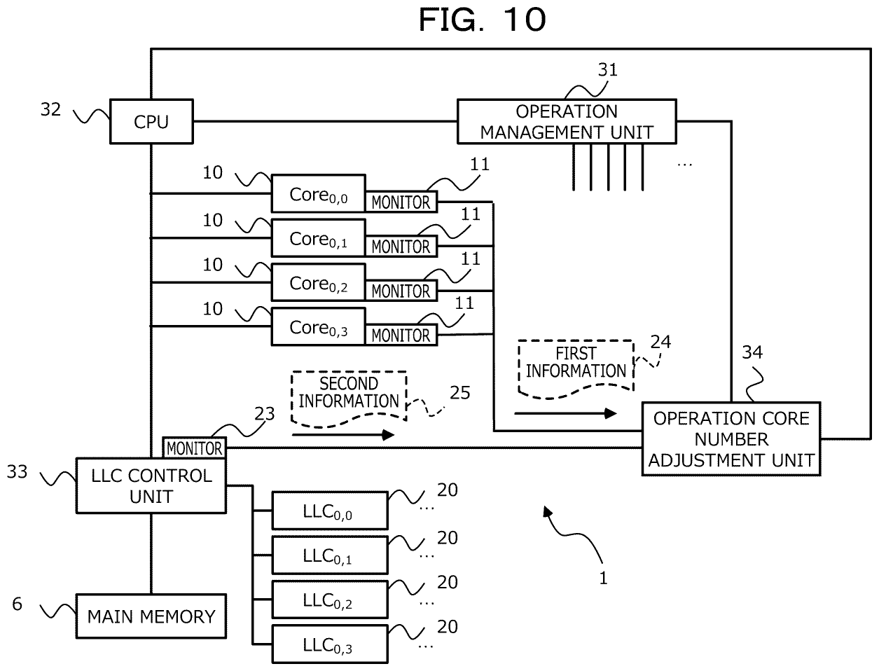

FIG. 10 is a circuit diagram of a second example of the arithmetic device 1. The arithmetic device 1 according to the second example obtains information regarding the usage rate of the plurality of arithmetic units 10 and the usage rate of the memory using a monitor 11 and a monitor 23. The operation management unit 31 operates the arithmetic unit 10 or the cache memory 20 according to a result of comparison between first information regarding the usage rate of the plurality of arithmetic units 10 and second information regarding the usage rate of the memory. The second example is suitably applied to a case of repeatedly executing similar arithmetic processing a plurality of times.

In the second example, the output of enable signals and disable signals from the operation management unit 31 is similar to that of the case of the first example, and thus display of terminals related to the enable signals and the disable signals are omitted in FIG. 10.

The arithmetic device 1 includes an operation core number adjustment unit 34, the monitor 11, and the monitor 23 in addition to the plurality of arithmetic units 10, the plurality of cache memories 20, the operation management unit 31, the CPU 32, the LLC control unit 33, and the main memory 6.

The CPU 32 may obtain the list 22 of the operation cores in the initial state based on a program or the like, and may transmit the list 22 to the operation management unit 31. Except for this point, configurations of the plurality of arithmetic units 10, the plurality of cache memories 20, the CPU 32, the LLC control unit 33, and the main memory 6 are similar to those of the case of the first example.

The monitor 11 obtains first information 24 regarding the usage rate of the plurality of arithmetic units 10. The monitor 23 obtains second information 25 regarding the usage rate of the plurality of cache memories 20.

The usage rate is also referred to as an operation rate. For example, the first information 24 may be the number of command executions per unit time in each of the arithmetic units 10 (Core_{i,j}), or may be the number of standby commands to be executed in each of the arithmetic units 10. The first information 24 may be the total number of command executions per unit time in the plurality of arithmetic units 10, or may be the total number of standby commands to be executed in the plurality of arithmetic units 10. However, the first information 24 is not limited to those cases, and only needs to be information regarding the usage rate of the arithmetic unit 10.

For example, the second information 25 may be a memory usage rate, a cache miss rate, a cache miss count, or a busy rate in the plurality of cache memories 20 as a whole. The cache miss rate may be a ratio of LLC cache misses to the number of times of load/store. The cache miss rate increases as the memory usage rate increases. The second information 25 may be a memory usage rate or the like in each of the cache memories 20. However, the second information 25 is not limited to those cases, and only needs to be information regarding the usage rate of the cache memory 20.

The operation core number adjustment unit 34 may be one of the functions of the operation management unit 31. The operation management unit 31 and the operation core number adjustment unit 34 may be implemented as one function of the CPU 32 provided in the logic die 2 or another die, or may be implemented by a dedicated circuit provided in at least one of the logic die 2 and the memory die 3.

The operation core number adjustment unit 34 obtains the first information 24 and the second information 25 from the monitor 11 and the monitor 23. The operation core number adjustment unit 34 compares the first information 24 with the second information 25. The operation core number adjustment unit 34 adjusts an increase or decrease in the number of arithmetic units 10 (referred to as operation cores) to be operated among the plurality of arithmetic units 10 in the plurality of pairs 30 according to a result of the comparison between the first information 24 and the second information 25. Since the arithmetic unit 10 and the cache memory 20 operate exclusively, it may be said that the operation core number adjustment unit 34 adjusts an increase and decrease in the number of cache memories 20 (referred to as operation memories) to be operated among the plurality of cache memories 20 in the plurality of pairs 30 according to the comparison result.

The operation core number adjustment unit 34 instructs the monitor 11 and the monitor 23 to reset before measurement.

The operation management unit 31 selectively operates either the arithmetic unit 10 or the cache memory 20 forming the pair 30 with each other according to the result of the comparison between the first information 24 and the second information 25 based on the instruction from the operation core number adjustment unit 34. For example, the operation management unit 31 increases or decreases the number of arithmetic units 10 (referred to as the number of operation cores) to be operated among the plurality of arithmetic units 10 in the plurality of pairs 30 according to the comparison result. Since the arithmetic unit 10 and the cache memory 20 operate exclusively, it may be said that the operation management unit 31 increases or decreases the number of cache memories 20 (referred to as the number of operation memories) to be operated among the plurality of cache memories 20 in the plurality of pairs 30 according to the comparison result.

### [B-2-2] Operation

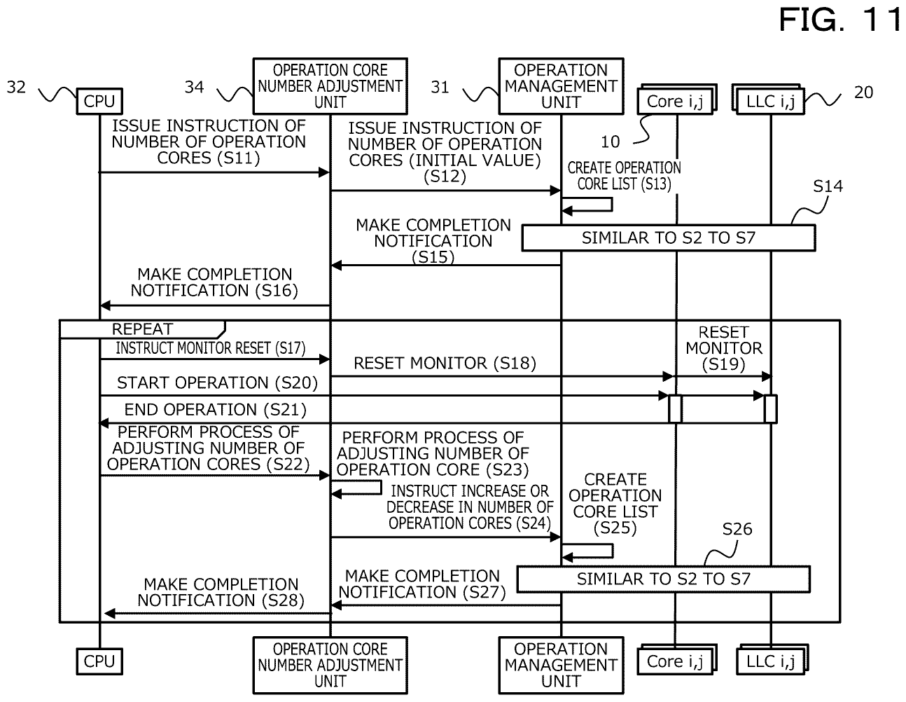

FIG. 11 is a sequence diagram of the arithmetic device 1 according to the second example. A process of operations S11 to S16 in FIG. 11 is related to designation of the arithmetic unit 10 and the cache memory 20 to be operated in the initial state. For example, the CPU 32 issues an instruction regarding the number of operation cores to the operation core number adjustment unit 34 such that the initial state as illustrated in FIG. 6A is entered (operation S11).

The operation core number adjustment unit 34 issues an instruction regarding the number of operation cores to the operation management unit 31 (operation S12). The operation management unit 31 creates the list 22 based on the instructed number of operation cores (operation S13). For example, a list corresponding to the state of FIG. 6A may be prepared in advance when the number of operation cores is 12, a list corresponding to the state of FIG. 6B may be prepared in advance when the number of operation cores is 8, and a list corresponding to the state of FIG. 6C may be prepared in advance when the number of operation cores is 14, for example. For example, numbers for identifying the operation cores may be provided in advance as the list 22 according to the number of the operation cores. The operation management unit 31 may select the list 22 corresponding to the instructed number of operation cores.

Since processing of operation S14 is similar to the processing of operations S2 to S7 in FIG. 9, descriptions thereof will be omitted. The operation management unit 31 notifies the operation core number adjustment unit 34 of completion notification (operation S15). The operation core number adjustment unit 34 notifies the CPU 32 of the completion notification (operation S16).

The CPU 32 instructs the operation management unit 31 to perform monitor reset on the monitor 11 and the monitor 23 (operation S17). The operation management unit 31 instructs the monitor reset of the monitor 11 and the monitor 23 (operations S18 and S19). As a result, the monitor 11 and the monitor 23 are enabled to newly measure and obtain the first information 24 and the second information 25.

The CPU 32 starts arithmetic processing based on the program content (operation S20). The arithmetic unit 10 and the cache memory 20 execute the arithmetic processing, data reading and writing, and the like. The CPU 32 receives operation completion notification from the arithmetic unit 10 (operation S21).

In the arithmetic processing that starts in operation S18, the monitor 11 and the monitor 23 may obtain the first information 24 and the second information 25, respectively. The arithmetic processing (operation S20) that starts first after completion of the process regarding the initial state (operations S11 to S16) is an example of first arithmetic processing.

The CPU 32 instructs the operation core number adjustment unit 34 to perform a process of adjusting the number of operation cores (operation S22). The operation core number adjustment unit 34 executes the process of adjusting the number of operation cores (operation S23). The process of adjusting the number of operation cores will be described later. The operation core number adjustment unit 34 instructs the operation management unit 31 to increase or decrease the number of operation cores (operation S24).

The operation management unit 31 determines the number of operation cores based on the instructed increase or decrease in the number of operation cores, and creates the list 22 based on the number of operation cores (operation S25).

Since processing of operation S26 is similar to the processing of operations S2 to S7 in FIG. 9, descriptions thereof will be omitted. The operation management unit 31 notifies the operation core number adjustment unit 34 of completion notification (operation S27). The operation core number adjustment unit 34 notifies the CPU 32 of the completion notification (operation S28).

The process returns to operation S17. Arithmetic processing is newly started (operation S18). The arithmetic processing executed second is an example of second arithmetic processing to be executed by any of the plurality of arithmetic units 10 after the first arithmetic processing. In the second arithmetic processing, the operation management unit 31 may selectively operate either the arithmetic unit 10 or the cache memory 20 according to a result of comparison between the first information 24 and the second information 25 obtained in the first arithmetic processing.

Hereinafter, in the repeated arithmetic processing, processing may be executed with the previous arithmetic processing as the first arithmetic processing and with the current arithmetic processing as the second arithmetic processing.

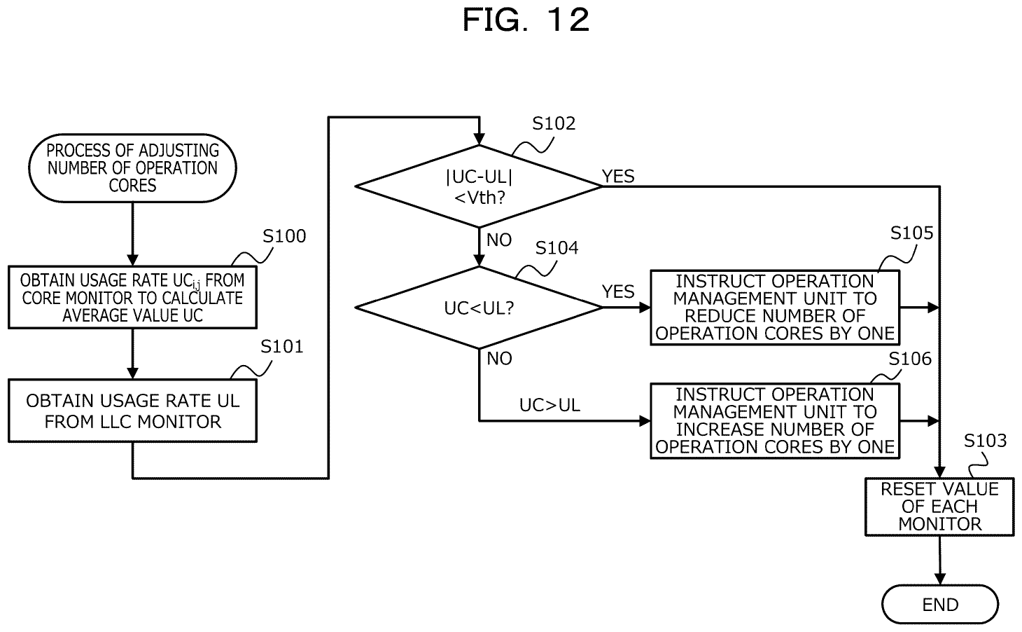

FIG. 12 is a flowchart illustrating an example of the process of adjusting the number of operation cores in FIG. 11. FIG. 12 may be an example of the processing of operation S23 in FIG. 11. In the process of FIG. 12, descriptions will be given using Core_{i,j} as an example of the arithmetic unit 10 and LLC_{i,j} as an example of the cache memory 20.

The operation core number adjustment unit 34 obtains a usage rate UCᵢⱼ of each Core_{i,j} from the monitor 11 of each Core_{i,j} (operation S100). The operation core number adjustment unit 34 calculates an average value of the individual usage rates UCᵢⱼ as a usage rate UC of the arithmetic units 10 (operation S100). However, the operation core number adjustment unit 34 may calculate, as the usage rate UC, the total value of the plurality of usage rates UCᵢⱼ, or may calculate an average value of the remaining usage rates obtained by deleting the top m pieces and the bottom n pieces of the plurality of usage rates UCᵢⱼ.

The operation core number adjustment unit 34 obtains a usage rate UL of the cache memories 20 (LLCs) from the monitor 23 of the LLC control unit 33 that controls LLC_{i,j} (operation S101). It is sufficient if the usage rate UL corresponds to UC, and it may be an average value of the individual LLC_{i,j}, a total value of the individual LLC_{i,j}, or may be an average value of the remaining usage rates obtained by deleting the top m pieces and the bottom n pieces of the plurality of usage rates LLC_{i,j}.

The operation core number adjustment unit 34 determines whether an absolute value |UC−UL| of the difference between the usage rate UC of the arithmetic units 10 and the usage rate UL of the cache memories 20 is lower than a threshold Vth (operation S102). If the absolute value |UC−UL| of the difference is smaller than the threshold Vth (see YES route of operation S102), the number of the operation cores is not particularly increased or decreased, and the process proceeds to operation S103. In operation S103, the operation core number adjustment unit 34 resets the values of the individual monitors 11 and 23 (operation S103).

On the other hand, if |UC−UL| is equal to or larger than the threshold Vth (see NO route of operation S102) and the usage rate UL of the cache memories 20 is higher than the usage rate UC of the arithmetic units 10 (see YES route of operation S104), the process proceeds to operation S105. In operation S105, the operation core number adjustment unit 34 instructs the operation management unit 31 to reduce the number of the operation cores by one. Note that, since the arithmetic unit 10 (core) and the cache memory 20 forming the pair 30 exclusively operate, the processing of operation S105 corresponds to instructing the operation management unit 31 to increase the number of the cache memories 20 to be operated by one.

If |UC−UL| is equal to or larger than the threshold Vth (see NO route of operation S102) and the usage rate UL of the cache memories 20 is equal to or lower than the usage rate UC of the arithmetic units 10 (see NO route of operation S104), the process proceeds to operation S106. In operation S106, the operation core number adjustment unit 34 instructs the operation management unit 31 to increase the number of the operation cores by one. Note that, since the arithmetic unit 10 (core) and the cache memory 20 forming the pair 30 exclusively operate, the processing of operation S106 corresponds to instructing the operation management unit 31 to reduce the number of the cache memories 20 to be operated by one.

After executing operation S105 or operation S106, the operation core number adjustment unit 34 resets the values of the individual monitors 11 and 23 (operation S103). After the processing of operation S103, the process is terminated.

According to the arithmetic device 1 according to the second example, in the three-dimensional stacked die 4 in which the arithmetic units 10 and the cache memories 20 are stacked, the influence exerted on the operation of the cache memories 20 caused by heat generation of the arithmetic units 10 may be reduced. The arithmetic unit and the cache memory to be operated are selected using a result of comparison between the usage rate UC of the arithmetic units 10 and the usage rate UL of the cache memories 20 obtained in the previous arithmetic processing among the series of repeated arithmetic processing. For example, the operation management unit 31 selectively operates the specific arithmetic unit 10 and the cache memory 20 such that the selected number of operation cores is obtained in the current operation.

### [B-3] Third Example

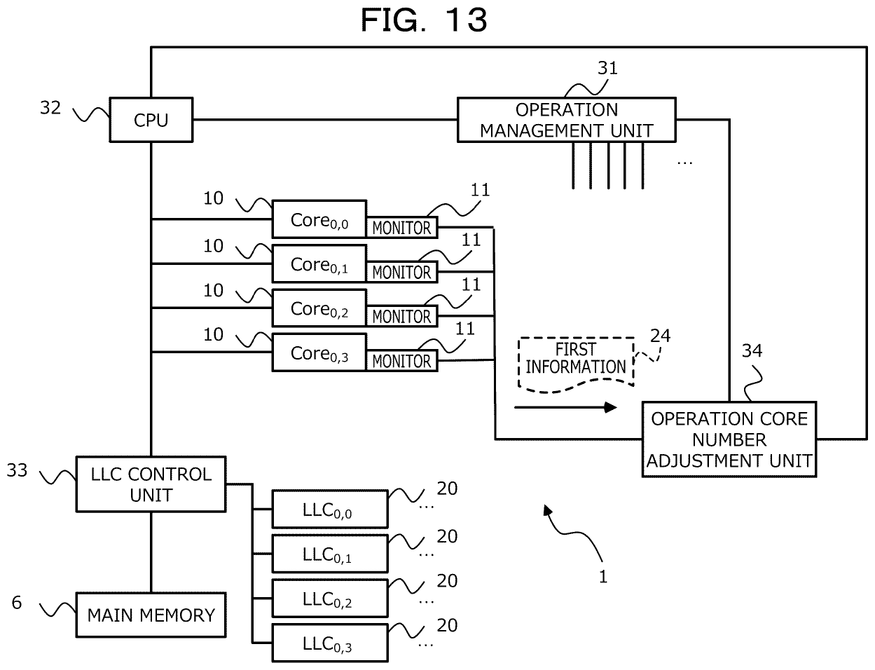

FIG. 13 is a circuit diagram of a third example of the arithmetic device 1. In the arithmetic device 1 according to the third example, the monitor 11 obtains a usage rate of the plurality of arithmetic units 10. The operation management unit 31 operates the arithmetic units 10 or the cache memories 20 according to a result of the acquisition of the usage rate of the plurality of arithmetic units 10. In the third example, the configuration for obtaining, using the monitor 23, the usage rate of the plurality of cache memories 20 and the related processing in the second example are omitted. Other configurations and processing are similar to those in the second example. Accordingly, detailed descriptions will be omitted. An instruction for reducing the number of operation cores by one may be issued when the usage rate UL of the arithmetic units 10 is lower than a first threshold, the number of operation cores may not be changed when UL is equal to or higher than the first threshold and lower than a second threshold, and an instruction for increasing the number of operation cores by one may be issued when UL is equal to or higher than the second threshold. Detailed descriptions will be omitted.

The specific arithmetic unit 10 and cache memory 20 may be selectively operated depending on the arithmetic intensity also based on the result of obtaining, using the monitor 11, the usage rate of the arithmetic units 10.

### [B-4] Fourth Example

A configuration of the arithmetic device according to a fourth example may be similar to the case of the second example or the third example. Accordingly, repetitive descriptions will be omitted.

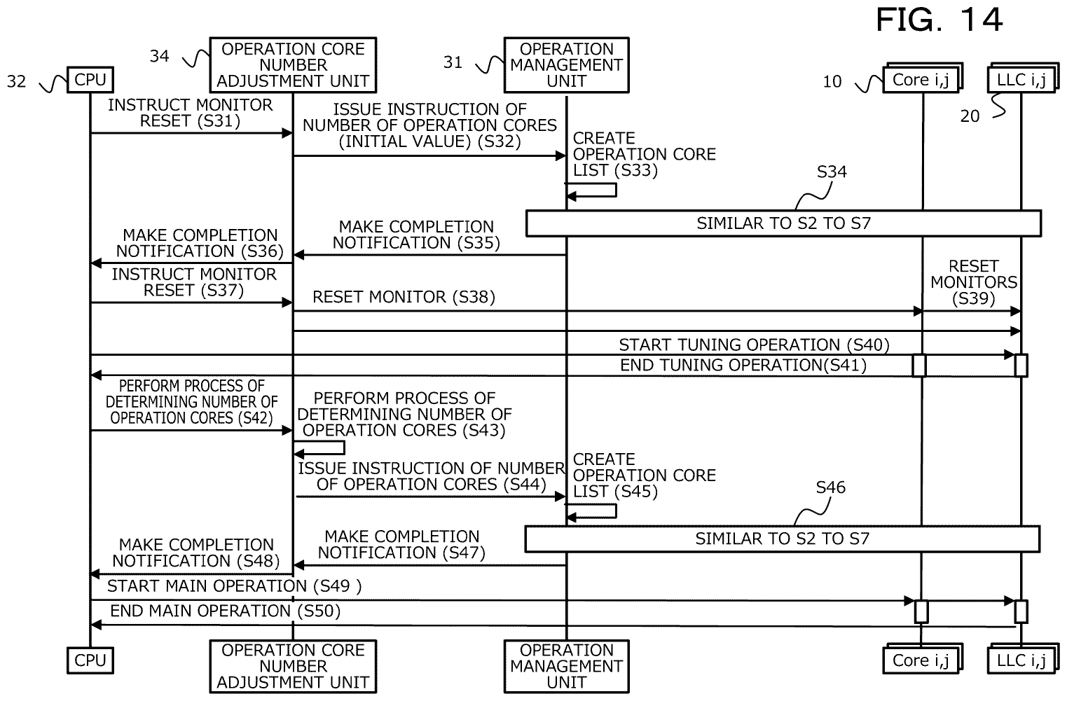

FIG. 14 is a sequence diagram of the arithmetic device 1 according to the fourth example. A process of operations S31 to S36 is similar to the process of operations S11 to S16 in the second example in FIG. 11.

In operations S37 to S41 in FIG. 14, arithmetic processing (operations S40 and S41) executed as the first arithmetic processing is different from that in the case of the second example. In the case of the second example, both the first arithmetic processing and the second arithmetic processing are arithmetic processing to be processed. Meanwhile, in the case of the fourth example, the first arithmetic processing is tuning arithmetic processing that starts in operations S40 and S41 in FIG. 14. The tuning arithmetic processing is exemplary adjustment arithmetic processing including a smaller number of commands than those of the arithmetic processing to be processed. A process of operations S37 to S39 is similar to the case of the second example.

The CPU 32 instructs the operation core number adjustment unit 34 to perform a process of determining the number of operation cores (operation S42). The operation core number adjustment unit 34 executes the process of determining the number of operation cores (operation S43). The process of determining the number of operation cores will be described later. The operation core number adjustment unit 34 issues an instruction regarding the determined number of operation cores to the operation management unit 31 (operation S44).

A process of operations S45 to S48 is similar to the process of operations S25 to S28 in FIG. 11.

The CPU 32 starts the main arithmetic processing to be processed based on the program content (operation S49). The arithmetic unit 10 and the cache memory 20 execute the arithmetic processing, data reading and writing, and the like. The CPU 32 receives notification regarding completion of the main arithmetic processing to be processed from the arithmetic unit 10 (operation S50).

The main arithmetic processing to be processed (operations S49 and S50) is an example of the second arithmetic processing.

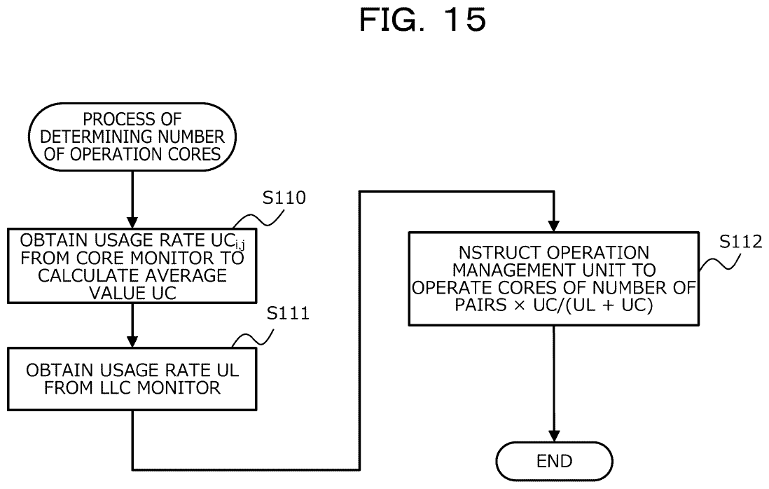

FIG. 15 is a flowchart illustrating an example of the process of determining the number of operation cores in FIG. 14. FIG. 15 may be an example of the processing of operation S43 in FIG. 14. In the process of FIG. 15, descriptions will be given using Core_{i,j} as an example of the arithmetic unit 10 and LLC_{i,j} as an example of the cache memory 20.

Since a process of operations S110 and S111 is similar to the process of operations S100 and S101 in FIG. 12, repetitive descriptions will be omitted.

Assuming that the total number of the pairs 30 is P, the operation core number adjustment unit 34 calculates the number of operation cores by an equation of the number of operation cores=P×the usage rate UC of Core/(the usage rate UC of Core +the usage rate of LLC) (operation S112). The usage rate UC of Core/(the usage rate UC of Core+the usage rate of LLC) indicates a ratio of the arithmetic units 10 to be operated among the plurality of arithmetic units 10 in the plurality of pairs 30.

Note that the operation management unit 31 and the operation core number adjustment unit 34 create the list 22 of the operation cores based on a result of the determination regarding the number of operation cores made by the operation core number adjustment unit 34, and selectively operate either the arithmetic unit 10 or the cache memory 20 in the pair 30 based on the list 22. The operation management unit 31 may cooperate with the operation core number adjustment unit 34. The operation management unit 31 controls the ratio of the arithmetic units 10 to be operated among the plurality of arithmetic units 10 in the plurality of pairs 30 according to a result of comparison between the first information 24, which is the usage rate UC of the arithmetic units, and the second information 25, which is the usage rate of the cache memories 20.

According to the arithmetic device 1 according to the fourth example, in the three-dimensional stacked die 4 in which the arithmetic units 10 and the cache memories 20 are stacked, the influence exerted on the operation of the cache memories 20 caused by heat generation of the arithmetic units 10 may be reduced. The operation management unit 31 selects the number of operation cores using the result of the comparison between the first information regarding the usage rate UC of the arithmetic units 10 and the second information regarding the usage rate UL of the cache memories 20 obtained in the tuning arithmetic processing. For example, even when the appropriate number of operation cores may not be gradually adjusted according to the plurality of types of arithmetic processing, the operation management unit 31 is enabled to control the ratio of the arithmetic units 10 to be operated among the plurality of arithmetic units 10 in the plurality of pairs 30.

### [B-5] Fifth Example

### [B-5-1] Configuration

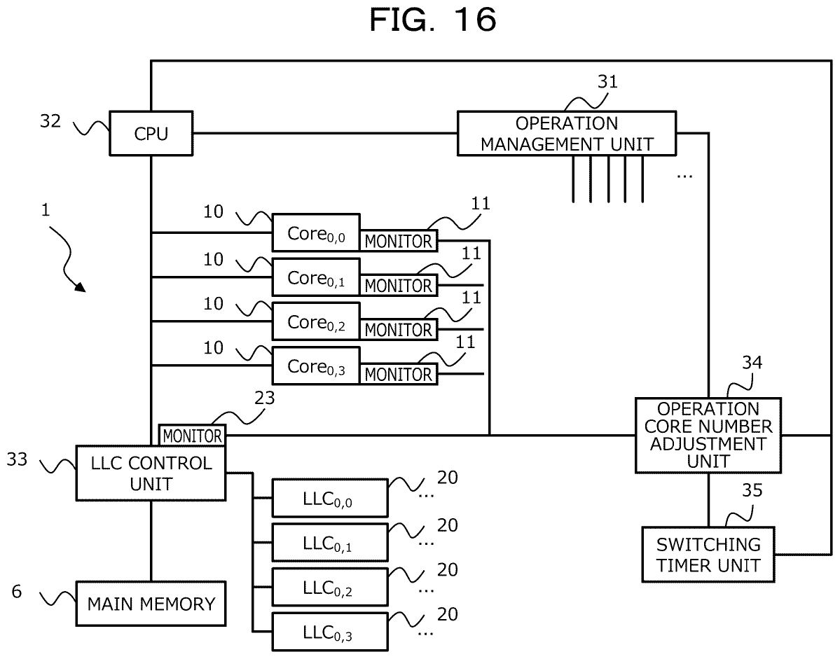

FIG. 16 is a circuit diagram of a fifth example of the arithmetic device 1. In the arithmetic device 1 according to the fifth example, the monitor 11 and the monitor 23 obtains the usage rate of the arithmetic unit 10 and the usage rate of the cache memory 20 at predetermined time intervals during the arithmetic processing executed by any of the plurality of arithmetic units 10.

The arithmetic device 1 is provided with a switching timer unit 35 in addition to the configurations of the second example illustrated in FIG. 10 and the third example illustrated in FIG. 13. The switching timer unit 35 may be a timer configured by an electronic circuit.

The switching timer unit 35 may be communicable with the CPU 32 and the operation core number adjustment unit 34. When the switching timer unit 35 receives a switching timer start instruction (e.g., start command) from the CPU 32, the arithmetic unit 10, or the like, it operates the operation core number adjustment unit 34 in a fixed cycle using a timer. The switching timer start instruction may include information regarding a switching cycle. The switching cycle may be preset by the user through a program or the like.

The configuration of the arithmetic device 1 according to the fifth example may be similar to that in FIGS. 10 and 13 except that the switching timer unit 35 is included. Accordingly, repetitive descriptions will be omitted.

### [B-5-2] Operation

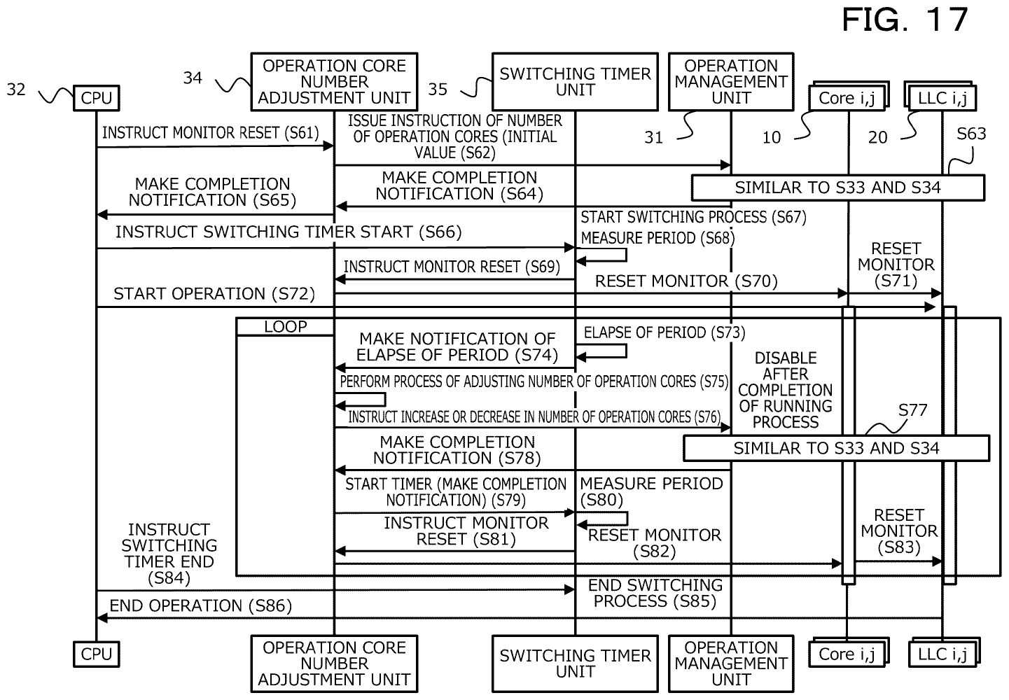

FIG. 17 is a sequence diagram of the arithmetic device 1 according to the fifth example. A process of operations S61 to S65 in FIG. 17 is similar to the process of operations S31 to S36 in FIG. 14.

The CPU 32 transmits a switching timer start instruction to the switching timer unit 35 (operation S66). The switching timer unit 35 starts switching processing of switching the number of operation cores and the like at predetermined time intervals (operation S67). The switching timer unit 35 starts measuring a period (operation S68).

The switching timer unit 35 instructs the operation core number adjustment unit 34 to execute monitor reset (operation S69). Note that a subsequent process of operations S70 to S72 is similar to that of operations S17 to S19 in FIG. 11.

In the fifth example, the usage rate of the arithmetic unit 10 and the usage rate of the cache memory 20 are obtained at the predetermined time intervals during the processing target arithmetic processing that starts in operation S72.

When a predetermined period has elapsed from the start of the measurement in operation S63 (operation S73), the switching timer unit 35 notifies the operation core number adjustment unit 34 of the fact that the period has elapsed (operation S74). The measurement time by the switching timer unit 35 may be reset.

A process of operations S75 to S78 corresponds to the process of operations S23 to S27 in FIG. 11. Accordingly, repetitive descriptions will be omitted.

However, in operation S77 (operation S4), the arithmetic unit 10 (Core_{i,j}) that has received a disable signal waits for completion of the running process, and enters a disabled (paused) state. The arithmetic unit 10 avoids pausing of itself during the process, thereby reducing the influence exerted on the arithmetic processing.

Upon reception of completion notification regarding an increase or decrease in the operation of the operation core and the operation cache memory (operation S78), the operation core number adjustment unit 34 notifies the switching timer unit 35 of a timer start with the reception of the completion notification as a trigger. For example, the operation core number adjustment unit 34 notifies the switching timer unit 35 of the completion notification. The switching timer unit 35 starts measuring a period (operation S80).

The switching timer unit 35 instructs the operation core number adjustment unit 34 to execute monitor reset (operation S81). A process of operations S82 and S83 is similar to that of operations S18 and S19 in FIG. 11.

After completion of operation S83, the process returns to operation S73 again. Until the switching timer unit 35 receives a switching timer completion instruction from the CPU 32 (operation S84), a loop process of repeating the process of operations S73 to S83 is executed. In the example illustrated in FIG. 17, the switching timer unit 35 starts measurement when the switching timer unit 35 is notified of the completion of the increase or decrease in the number of operations with respect to the operation core and the operation cache memory (operation S80).

The switching timer unit 35 waits for elapse of the predetermined period corresponding to the switching cycle (operation S73 after the return), and then the number of operation cores and the number of operation memories are increased or decreased. Moreover, when the switching timer unit 35 is notified of the completion of the increase or decrease in the number of operation cores and the number of operation memories (operation S79), the switching timer unit 35 starts measuring a period (operation S80). The switching timer unit 35 waits for elapse of the predetermined period corresponding to the switching cycle (operation S73 after the further return), and then the number of operation cores and the number of operation memories are increased or decreased.

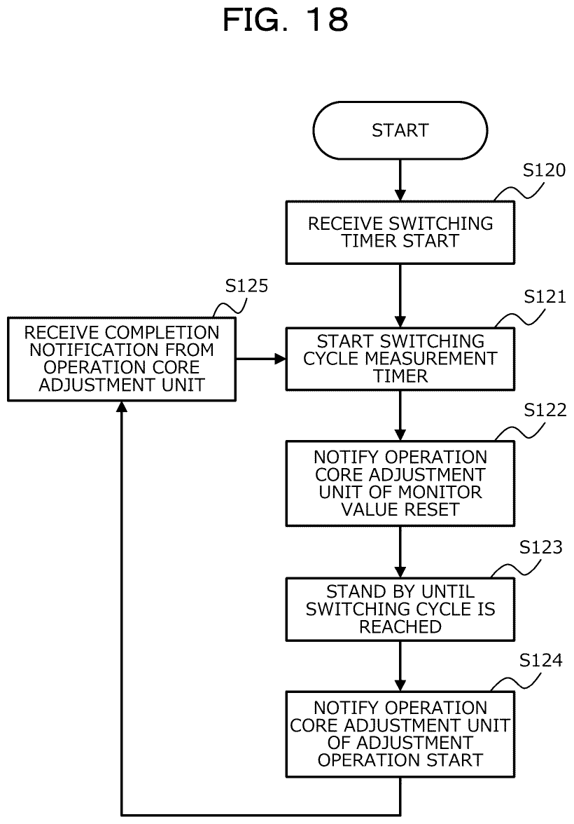

FIG. 18 is a flowchart illustrating an example of the timer process in FIG. 17. FIG. 18 is a flowchart illustrating an example of the timer process in operations S66 to S79 in FIG. 17.

The switching timer unit 35 receives a switching timer start instruction (operation S120).

The switching timer unit 35 starts clocking for the period corresponding to the switching cycle using a measurement timer (operation S121). When the switching timer unit 35 starts clocking for the period corresponding to the switching cycle (operation S121), it notifies the operation core number adjustment unit 34 of a monitor value reset instruction (operation S122).

The switching timer unit 35 stands by until the switching cycle is reached (operation S123). When the period corresponding to the switching cycle has elapsed, the switching timer unit 35 notifies the operation core number adjustment unit 34 of a start of adjustment operation regarding the number of operation cores (operation S124). The value of the measurement period is reset.

When the switching timer unit 35 receives completion notification from the operation core number adjustment unit 34 (operation S125), the switching timer unit 35 newly starts clocking for the period corresponding to the switching cycle using the measurement timer (operation S121).

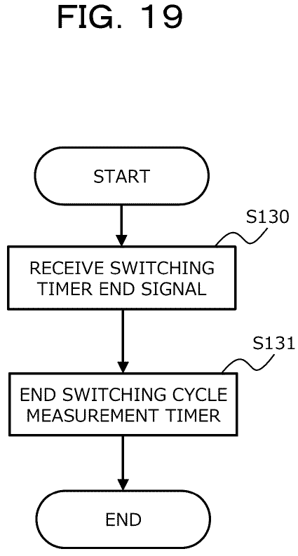

FIG. 19 is a flowchart illustrating the process of terminating the timer process in FIG. 17. FIG. 19 is a flowchart illustrating an example of the process of operations S84 and S85 in FIG. 17.

When the switching timer unit 35 receives a switching timer end signal (end instruction) from the CPU 32 (operation S130), the switching timer unit 35 terminates the processing of periodic clocking of the period corresponding to the switching cycle (operation S131).

According to the arithmetic device 1 according to the fifth example, in the three-dimensional stacked die 4 in which the arithmetic units 10 and the cache memories 20 are stacked, the influence exerted on the operation of the cache memories 20 caused by heat generation of the arithmetic units 10 may be reduced. The number of operations is adjusted in the arithmetic processing to be processed with respect to the arithmetic unit 10 and the cache memory 20 selected according to the arithmetic intensity. For example, since the number of operations is periodically adjusted using the switching timer unit 35, the operation management unit 31 is enabled to selectively operate the specific arithmetic unit 10 and cache memory 20 depending on the arithmetic intensity.

### [B-6] Variations

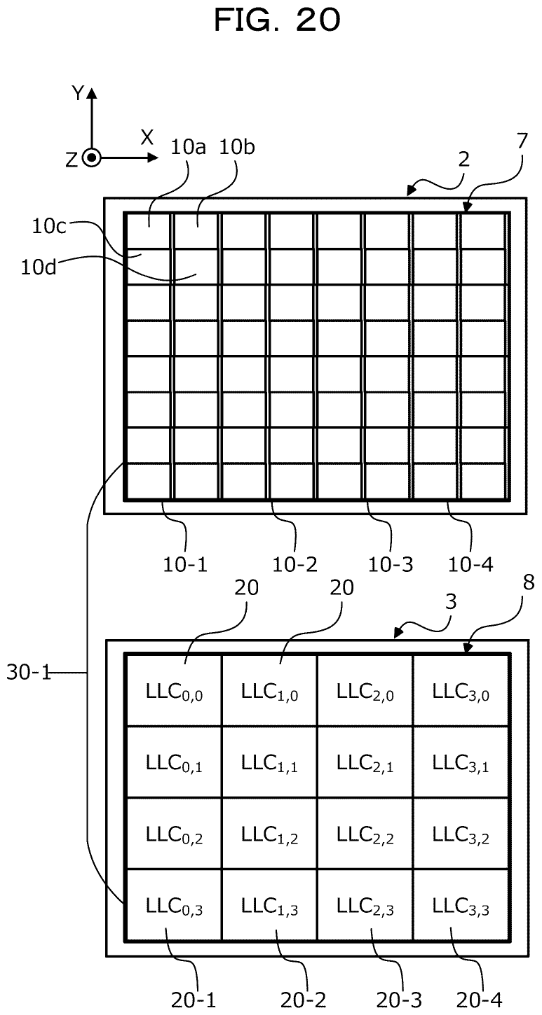

FIG. 20 is a top view illustrating variations of the logic die and the memory die in the arithmetic device 1.

For example, while the case of forming one pair 30 (group) with one arithmetic unit 10 (Core) and one cache memory 20 has been described in the descriptions above, the disclosed technique is not limited to this case. As illustrated in FIG. 20, N arithmetic units 10 (Cores) and one cache memory 20 may form one pair 30 (group). Here, N is an integer of 2 or larger.

FIG. 20 illustrates a case where four (N=4) arithmetic units (Cores) 10a, 10b, 10c, and 10d and one cache memory 20 form one pair 30 (group).

The N arithmetic units 10a to 10d and one LLC at least partially overlap each other in plan view. When the number of operations of the arithmetic units 10a, 10b, 10c, and 10d paired with one cache memory 20 is smaller than a threshold nth, the arithmetic units 10a to 10d may be defined to be in an off state. The operation management unit 31 may operate the cache memory 20 forming the pair 30 only when the arithmetic units 10a to 10d are in the off state. A case where the number of operations of the arithmetic units 10a, 10b, 10c, and 10d is equal to or larger than the threshold nth may be defined as an on state of the arithmetic units 10a to 10d. When the arithmetic units 10a to 10d are in the on state, the operation management unit 31 may pause the cache memory 20 forming the pair 30.

Moreover, N arithmetic units 10 and M cache memories 20 may form one pair 30. Here, N and M are integers of 2 or larger. Also in this case, the cache memories 20 may be determined to be in the off state when the number of operations of the M cache memories 20, which form one pair 30 (group), is smaller than a threshold mₜₕ, and the arithmetic units 10 forming the pair 30 may be operated only in the case of the off state. The cache memories 20 may be determined to be in the on state when the number of operations of the M cache memories 20 is equal to or larger than the threshold mₜₕ, and the arithmetic units 10 forming the pair 30 may be paused in the case of the on state.

When the plurality of arithmetic units 10 forms a group, the plurality of arithmetic units 10 may belong to a plurality of groups. Likewise, when the plurality of cache memories 20 forms a group, the plurality of cache memories 20 may belong to a plurality of groups.

### [C] Effects

According to the arithmetic device 1 according to the embodiment described above, for example, the following operational effects may be exerted.

The arithmetic device 1 includes the logic die 2 including the plurality of arithmetic units 10, and the memory die 3, which includes the plurality of cache memories 20 to form the pair 30 with any of the arithmetic units 10 of the plurality of arithmetic units 10 and is stacked over the logic die 2. The arithmetic device 1 includes the operation management unit 31 that manages the operation of the logic die 2 and the memory die 3. The arithmetic unit 10 and the cache memory 20, which form the pair 30, at least partially overlap each other in plan view. The operation management unit 31 selectively operates either the arithmetic unit 10 or the cache memory 20, which forms the pair 30 with the arithmetic unit 10, depending on the arithmetic intensity needed for the plurality of arithmetic units 10.

As a result, in the three-dimensional stacked die 4 in which the arithmetic units 10 and the cache memories 20 are stacked, the influence exerted on the operation of the cache memories 20 caused by heat generation of the arithmetic units 10 may be reduced.

For example, the cache memories 20 and the arithmetic units 10 (e.g., cores), which execute an operation to be processed and have a large heat radiation amount, may be stacked. Thus, the number of cores and the number of cache memories 20 that may be mounted within a predetermined space may be increased, whereby the capacity of the cache memories 20 may be enhanced and the computing power of the arithmetic units 10 may be enhanced in the arithmetic device 1.

Since the arithmetic unit and the cache memory forming the pair 30 may be exclusively used, a heat problem in the three-dimensional stacked die 4 may be avoided.

The operation management unit 31 determines the arithmetic unit 10 or the cache memory 20 to be operated in the plurality of pairs based on the list 22 for specifying the arithmetic unit 10 or the cache memory 20 to be operated in advance.

As a result, physical measurement of the arithmetic intensity may be omitted, whereby the processing time and the notification data volume for obtaining and reflecting the measurement result may be reduced. The programmer is enabled to grasp a state in which the operation state of the specific arithmetic units 10 or cache memories 20 is switched.

The arithmetic device 1 further includes the monitor 11 for obtaining the first information 24 regarding the usage rate UC of the plurality of arithmetic units 10. The operation management unit 31 selectively operates either the arithmetic unit 10 or the cache memory 20 forming the pair 30 with each other according to the first information 24 regarding the usage rate UC of the arithmetic units 10.

As a result, the operation may be appropriately selected depending on the arithmetic intensity based on the usage rate actually measured by the monitor 11.

The arithmetic device 1 further includes the monitor 23 for obtaining the second information 25 regarding the usage rate UL of the plurality of cache memories 20. The operation management unit 31 selectively operates either the arithmetic unit 10 or the cache memory 20 forming the pair 30 with each other according to a result of comparison between the first information 24 regarding the usage rate UC of the arithmetic units 10 and the second information 25 regarding the usage rate UL of the cache memories 20.

As a result, either the arithmetic unit 10 or the cache memory 20 may be selectively operated in consideration of both the state of the arithmetic unit 10 and the state of the cache memory 20 regarding whether the state is the operation bottleneck region or the memory bottleneck region.

In the first arithmetic processing executed by any of the plurality of arithmetic units 10, the monitor 11 and the monitor 23 obtain the first information 24 and the second information 25, respectively. In the second arithmetic processing executed by any of the plurality of arithmetic units 10 after the first arithmetic processing, the operation management unit 31 selectively operates either the arithmetic unit 10 or the cache memory 20 according to the result of the comparison between the first information 24 and the second information 25.

As a result, the number of the arithmetic units 10 to be operated in the current operation may be selected using a result of comparison between the usage rate UC of the arithmetic units 10 and the usage rate UL of the cache memories 20 obtained in the previous operation.

The operation management unit 31 controls the ratio of the arithmetic units 10 to be operated among the plurality of arithmetic units 10 in the plurality of pairs 30 according to the result of the comparison between the first information 24 and the second information 25.

As a result, the ratio of the arithmetic units 10 to be operated is controlled according to the result of the comparison between the first information 24 and the second information 25. Thus, the adjustment time is shortened as compared with the control of gradually increasing or decreasing the number of operations of the arithmetic unit 10. Furthermore, the information communication data volume regarding the measurement results by the monitor 11 and the monitor 23 is reduced as compared with the control of gradually increasing or decreasing the number of operations of the arithmetic unit 10.

In the first arithmetic processing executed by any of the plurality of arithmetic units 10, the monitor 11 and the monitor 23 obtain the first information 24 and the second information 25, respectively. In the second arithmetic processing executed by any of the plurality of arithmetic units 10 after the first arithmetic processing, the operation management unit 31 selectively operates either the arithmetic unit 10 or the cache memory 20 according to the result of the comparison between the first information 24 and the second information 25.

As a result, the first information 24 and the second information 25 may be obtained in the first arithmetic processing, and either the arithmetic unit 10 or the cache memory 20 may be selectively operated in the next second arithmetic processing. Thus, the selection operation of the arithmetic unit 10 and the cache memory 20 may be executed according to the progress of the plurality of types of arithmetic processing.

The second arithmetic processing is arithmetic processing to be processed, and the first arithmetic processing is arithmetic processing for adjustment, which is executed prior to the arithmetic processing to be processed and includes a smaller number of commands than those in the second arithmetic processing.

As a result, an influence of the acquisition of the first information 24 and the second information 25 exerted on the arithmetic processing to be processed is reduced. Deterioration of the performance of the arithmetic processing to be processed may be suppressed.

The monitor 11 and the monitor 23 obtain the first information 24 and the second information 25 at the predetermined time intervals during the arithmetic processing executed by any of the plurality of arithmetic units 10.

As a result, even when one arithmetic processing to be processed continues, acquisition of the first information 24 and the second information 25 may be started without waiting for completion of the one arithmetic processing.

The plurality of cache memories 20 operates as one cache memory as a whole.

As a result, even when the cache memories 20 are paused, they operate as one cache memory as a whole, thereby enhancing controllability.

### [D] Others

The disclosed technique is not limited to the embodiment described above, and various modifications may be made and carried out in a range without departing from the spirit of the present embodiment. Each configuration and each process of the present embodiment may be selected or omitted as needed, or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A cache memory equipped arithmetic device comprising:
a first semiconductor die configured to include a plurality of arithmetic circuits;
a second semiconductor die stacked over the first semiconductor die, and configured to include a plurality of cache memories, a cache memory of the plurality of cache memories forming a pair with an arithmetic circuit of the plurality of arithmetic circuits; and
an operation management circuit configured to manage operation of the first semiconductor die and the second semiconductor die,
wherein the arithmetic circuit and the cache memory, which form the pair, at least partially overlap each other in plan view, and
wherein the operation management circuit selectively operates one of the arithmetic circuit and the cache memory paired with the arithmetic circuit, based on arithmetic intensity needed for the plurality of arithmetic circuits.

2. The cache memory equipped arithmetic device according to claim 1, wherein the operation management circuit determines one of the arithmetic circuit and the cache memory to be operated in the pair of a plurality of pairs, based on a list for specifying, in advance, one of the arithmetic circuit and the cache memory to be operated.

3. The cache memory equipped arithmetic device according to claim 1, further comprising:
a first monitor configured to obtain first information regarding a usage rate of at least one of the plurality of arithmetic circuits,
wherein the operation management circuit selectively operates one of the arithmetic circuit and the cache memory paired with each other according to the first information.

4. The cache memory equipped arithmetic device according to claim 3, further comprising:
a second monitor configured to obtain second information regarding a usage rate of at least one of the plurality of cache memories,
wherein the operation management circuit selectively operates one of the arithmetic circuit and the cache memory paired with each other according to a result of comparison between the first information and the second information.

5. The cache memory equipped arithmetic device according to claim 4, wherein the operation management circuit controls a ratio of the arithmetic circuit to be operated among the plurality of arithmetic circuits in the pair of a plurality of pairs according to the result of comparison between the first information and the second information.

6. The cache memory equipped arithmetic device according to claim 4,
wherein the first monitor and the second monitor obtain the first information and the second information, respectively, in first arithmetic processing executed by any of the plurality of arithmetic circuits, and
wherein the operation management circuit selectively operates one the arithmetic circuit and the cache memory according to the result of comparison between the first information and the second information in second arithmetic processing executed by any of the plurality of arithmetic circuits after the first arithmetic processing.

7. The cache memory equipped arithmetic device according to claim 6,
wherein the second arithmetic processing includes arithmetic processing to be processed, and
wherein the first arithmetic processing includes arithmetic processing for adjustment that is executed prior to the second arithmetic processing and includes a smaller number of commands than a number of commands in the second arithmetic processing.

8. The cache memory equipped arithmetic device according to claim 4, wherein the first monitor and the second monitor obtain the first information and the second information at a predetermined time interval during arithmetic processing executed by any of the plurality of arithmetic circuits.

9. The cache memory equipped arithmetic device according to claim 1, wherein the plurality of cache memories operates as one cache memory as a whole.
